(19) United States
(12) Patent Application Publication
(10) Pub. No.: US 2018/0230060 A1
(43) Pub. Date: Aug. 16, 2018

(54) RARE EARTH PHOSPHATE BASED NON REACTIVE AND NON-WETTABLE SURFACES

(71) Applicant: Council of Scientific and Industrial Research, New Delhi (IN)

(72) Inventors: Sankar SASHIDHARAN, Thiruvananthapuram (IN); Rajesh KOMBAN, Thiruvananthapuram (IN); Abdul Azeez Peer MOHAMED, Thiruvananthapuram (IN); Solaiappan ANATHAKUMAR, Thiruvananthapuram (IN); Unnikrishnan Nair Saraswathy HAREESH, Thiruvananthapuram (IN); Krishna Gopakumar WARRIER, Thiruvananthapuram (IN)

(21) Appl. No.: 15/514,390

(22) PCT Filed: Sep. 24, 2015
(86) PCT No.: PCT/IN2015/050120

§ 371 Date: Mar. 24, 2017

(30) Foreign Application Priority Data
Sep. 24, 2014 (IN) 2737/DEL/2014

(51) Int. Cl. C04B 35/628; C04B 41/50; C04B 26/28; C04B 26/04; C04B 24/32; C04B 24/04

(52) U.S. Cl. CPC C04B 35/62881; C04B 41/5048; C04B 26/285; C04B 35/62231; C04B 24/32; C04B 24/045; C04B 26/04

(57) ABSTRACT

The present invention provides the use of lanthanum phosphate for creating non wetting, non-reactive surfaces for molten metals like zinc and aluminium. By virtue of this property, lanthanum phosphate finds extensive applications in metallurgical industry for metal casting.

### FIELD OF THE INVENTION

The present invention relates to the development of rare earth phosphate based non-reactive and non-wettable surface for molten metals. Particularly, present invention relates to rare earth phosphate based surface as non-reactive and non-wettable for molten metals for high temperature applications such as mould release coatings for metal casting.

### BACKGROUND OF THE INVENTION

Rare earth phosphates possess excellent high temperature phase stability, low thermal conductivity and diffusivity, good corrosion resistance and high thermal expansion coefficient. By virtue of these characteristics, lanthanum phosphate, a member of the rare earth phosphates family, has been employed for applications as thermal barrier coatings to metallic substrates. It is considered as a potential material for thermal insulation coating on Ni-based superalloys as its properties are comparable to the properties of zirconia like high-temperature stability (melting point 2345±20 K), high thermal expansion and low thermal conductivity. In addition, lanthanum phosphate (LaPO₄) is expected to have good corrosion resistance in environments containing sulfur and vanadium salts. However a careful control of the LaPO₄ stoichiometry is essential to employ such materials as TBCs primarily due to the fact that LaPO₄ is a line compound that melts congruently and small deviations from stoichiometry change its solidus temperature from 2343 K to 1853 K on the La-rich side or to 1323 K on the P-rich side.

Conventional solid state reactions of lanthanum phosphate necessitate high temperatures for phase formation and are also characterised by particles of irregular size and shape due to which post preparative milling techniques are required. In view of this a host of solution based preparative techniques like sol gel, co-precipitation, hydrothermal, sonochemical methods are now been developed to synthesise lanthanum phosphate particles of controlled size, morphology and composition. However, the bulk production of such particles is based on a spray calcination procedure where in the sol is atomised and fed into a heated chamber leading to the formation of particles with desirable characteristics.

In the U.S. Pat. No. 6,863,999B1 lanthanum phosphate is used to form thermal barrier coatings to protect super alloy and ceramic parts exposed to high temperature and damage by sulfur, vanadium, phosphorus and other contaminants. The coatings, between 10 and 500 micrometers in thickness, can be deposited on substrates having temperatures between 750-950° C. by common application methods such as EB-PVD, laser ablation and plasma spraying. The most effective coatings are crystalline and show a columnar structure with feather-like microstructure.

The U.S. Pat. No. 5,858,465A describes a method to coat SiC and oxide fibers with phosphate coatings to enhance the ceramic or metal matrix reinforcing properties of fibers. The phosphate coatings applied with the described method can also be employed for encapsulating radioactive waste. The U.S. Pat. No. 6,190,780 B1 (2001) reveals a means of surface treatment of metals for corrosion resistance where the coating layers are composed of rare earth elements of cerium and lanthanum in a resin. A colloidal dispersion containing rhabdophane structured rare earth phosphate and a polyphosphate is disclosed by US patent 2007/0131906. The said dispersion was used to develop transparent luminescent material. A corrosion protecting coating composition, for steel and aluminium surfaces, comprising of rare earth based corrosion inhibitors with a resin and curing agent was invented by the patent US 2005/0215670 A1.

U.S. Pat. No. 7,122,581 B1 reveals a process for cerium and/or lanthanum phosphate sol by introducing a first solution of salts of at least one of the rare earths into a second solution of phosphate ions with an initial pH of less than 2 and controlling the pH of the precipitation at a constant value of less than 2. The precipitate separated from the reaction medium can be further dispersed in water with a final PO₄/rare earth mole ratio of 1. The sol is employed as polishing suspensions

In metal casting operations the moulds are usually coated with layers of release agents comprising mainly of inorganic materials like alumina, zirconia, hexagonal BN, graphite etc. The layers acting as an interfacial coating prevents chemical interaction with mould material and casting metal. It is beneficial and advantageous to identify and develop suitable mould release agents that are easy to synthesize and are relatively of low costs compared to existing prior art articles

### SUMMARY OF INVENTION

Accordingly, present invention provides a process for rare earth phosphate based non-reactive and non-wettable surface comprising the steps of:
i. adding rare earth phosphate nanorod powders in water and/or solvent to obtain a slurry having solid loading in the range of 1-75 wt %;
ii. incorporating binders and plasticizers in to the slurry as obtained in step (i) to prepare the formulation;
iii. spraying or dipping the formulation as obtained in step (ii) on surface to obtain rare earth phosphate based non-reactive and non-wettable surface.

In an embodiment of the present invention, rare earth phosphate used is a single rare earth element or a mixture of rare earth elements derived from thorium depreciated monazite sand.

In another embodiment of the present invention, surface used is selected from glass, metals and ceramics.

In yet another embodiment of the present invention, solvent used are organic solvent and selected from ethanol or isoparopanol.

In yet another embodiment of the present invention, binders used are selected from polyvinyl alcohol, methyl cellulose, ethyl cellulose, poly vinyl pyrrolidone.

In yet another embodiment of the present invention, plasticizer used are selected from polyethylene glycol and dioctyle pthalate.

In yet another embodiment of the present invention, said surface is in the form of coating, mould or paint.

In yet another embodiment of the present invention, said non reactive coating, mould or paint is useful in holding the molten metal without chemically reacting at the melting temperatures for 2-5 h.

In yet another embodiment of the present invention, molten metal are either alone or in combination with alloys, metal composites, transition metals and semi-metals, wherein the molten metal are selected from Iron, Aluminium, Silver or Zinc.

In yet another embodiment of the present invention, formulation as prepared in step (ii) is useful as paints.

In yet another embodiment of the present invention, slurry as prepared in step (i) is useful in coating of crucibles/containers and the said process comprising the steps of:
i. casting the slurry as obtained in step (i) of claim 1 to monoliths in the form of cylindrical crucibles of varying volumes in suitable porous moulds;
ii. drying the monoliths and sintering the dried shapes in the temperature range of 1350-1550° C. to obtain rare earth phosphate based non-reactive and non-wettable crucibles/containers.

In yet another embodiment of the present invention, the surface is made of a dispersion (sol/slurry) containing ReP particles wherein the smallest dimension of the particles are in the range between 1 nm and 10 microns and wherein any dimension of majority of the particles have sizes in the range between 10 nm and 1 micron And wherein the particles have a rod like structure with an aspect ratio value in the range of 1-100.

In yet another embodiment of the present invention, dispersion/sols/slurrys made in to the form of mould release coating sprays/solutions.

### BRIEF DESCRIPTION OF DRAWINGS

FIG. 1: Flow chart of the mixed rare earth phosphate powder preparation.

FIG. 2: Viscosity vs. shear rate of slurries with varying solid loading for casting.

FIG. 3: Free standing lanthanum phosphate monolith prepared by the casting process.

FIG. 4: TG-DTA pattern of the powder mixture containing lanthanum phosphate and zinc metal.

FIG. 5: TG-DTA pattern of the powder mixture containing lanthanum phosphate and aluminium metal.

FIG. 6: EDAX spectrum of lanthanum phosphate powders after heat treatment at temperatures greater than 750° C.

FIG. 7: Free standing lanthanum phosphate article after melting operations with aluminium metal.

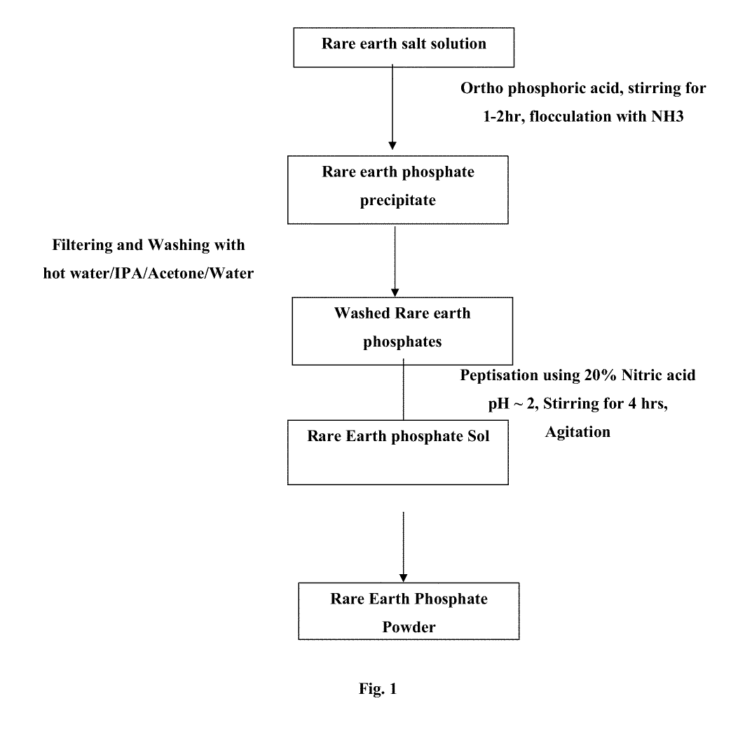

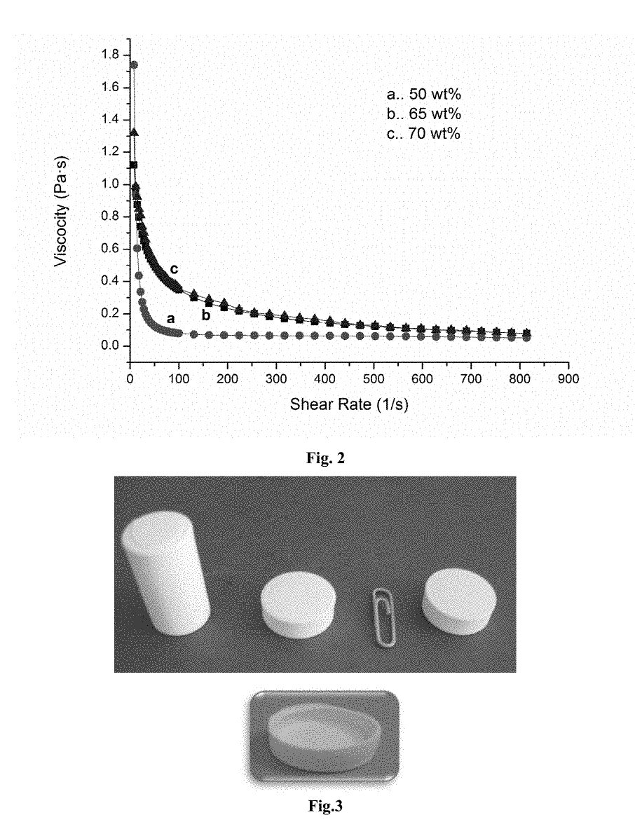

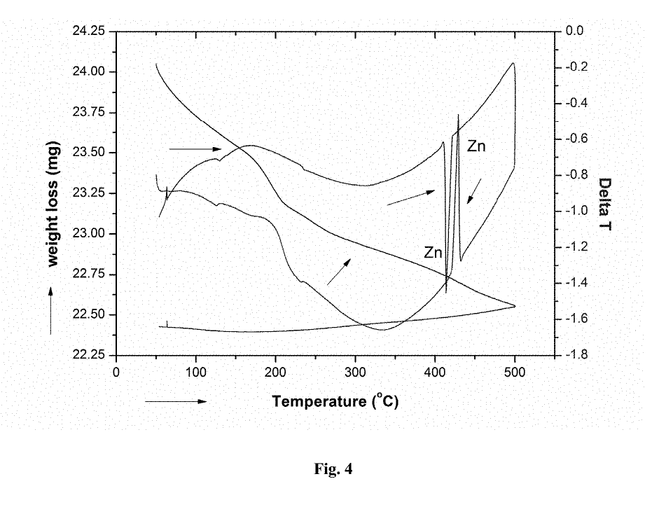

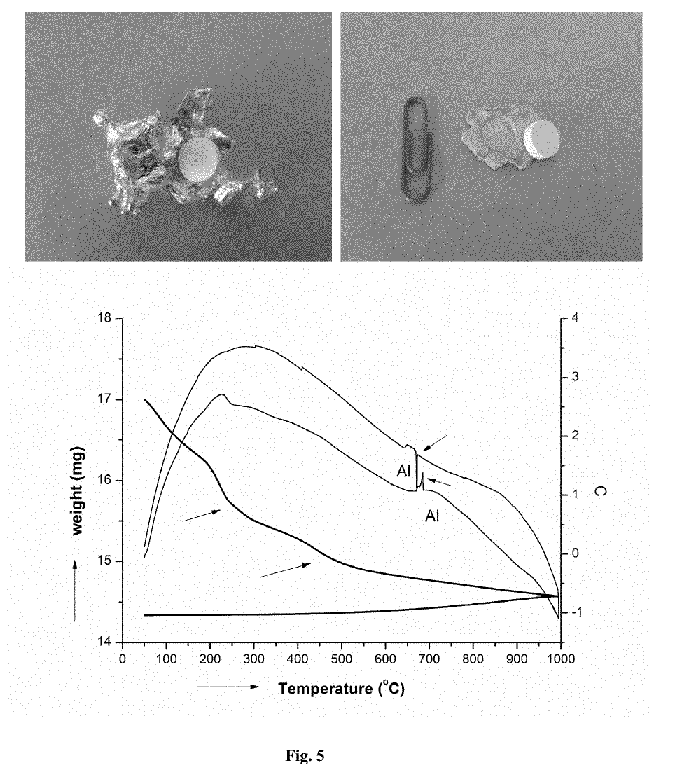

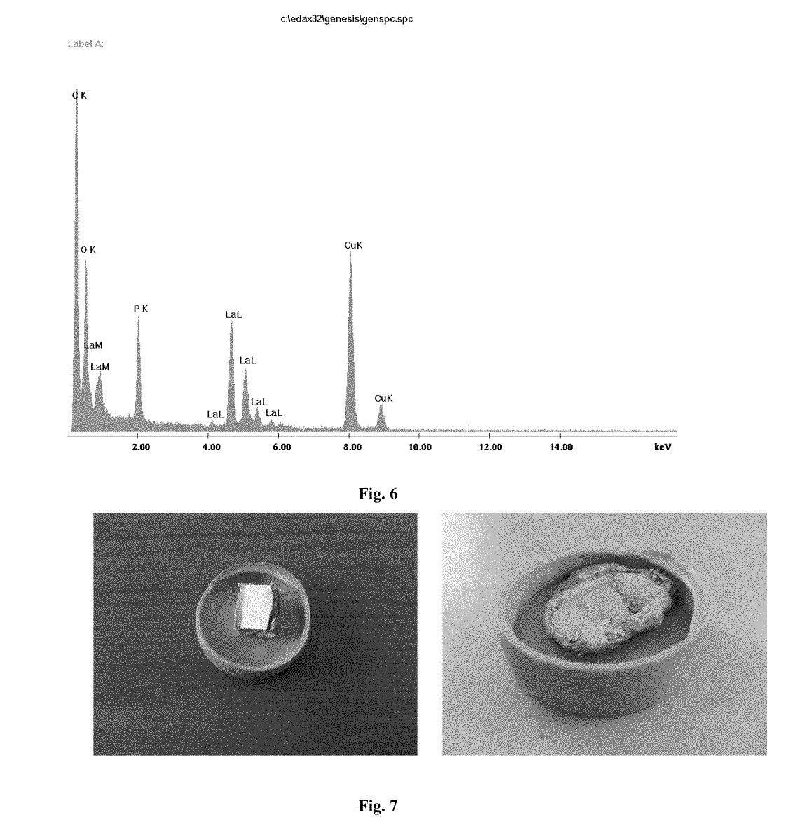

### DETAILED DESCRIPTION OF THE INVENTION

The present invention relates to the process of preparation of rare earth phosphate based non-reactive and non-wettable surface for molten metals for high temperature applications such as mould release coatings or crucibles for metal casting and the said process comprising the steps of:
i. adding rare earth phosphate nanorod powders in water and/or organic solvents like ethanol, isoparopanol to obtain a slurry having solid loading in the range of 1-30 wt %
ii. Preparation of paint formulations based on the aqueous slurry or sprayable formulations based on aqueous/organic slurry by incorporating suitable binders and plasticizers.
iii. Spray/Dip coating rare earth phosphate layers on substrates of glass, metals and ceramics.
iv. Melting of metals like Zn, Al, Ag in the rare earth phosphate coated monoliths and holding at the melting temperatures for 2-5 h
v. adding lanthanum phosphate nanorod powders in water to obtain an aqueous slurry having solid loading in the range of 60 to 75 wt %;
vi. casting the slurry as obtained in step (ii) to monoliths in the form of cylindrical crucibles of varying volumes in suitable porous moulds;
vii. drying the monoliths and sintering the dried shapes in the temperature range of 1350-1550° C. to obtain crucibles/containers
viii. Melting of metals like Zn, Al, Ag in the lanthanum phosphate containers and holding at the melting temperatures for 2-5 h.

The present invention also relates to the dispersion of lanthanum phosphate in the form of nanorods in aqueous medium with use of suitable dispersants to arrive at coating formulation that can be applied to substrates by the methods of dipping, spraying and casting.

The present invention also relates to the shaping of lanthanum phosphate dispersions in aqueous media to shaped monoliths of varying sizes and shape followed by the drying and sintering of the same to impart mechanical strength.

The present invention also demonstrates the suitability of such monoliths as metal melting crucibles without any reaction between each other.

The present invention also demonstrates the suitability of coatings developed from lanthanum phosphate as mould release agents in metal melting applications.

Lanthanum phosphate sample of the present invention prepared by slurry based colloidal forming technique of casting is demonstrated to be non wetting and non reacting to molten metals of zinc and aluminium. Additionally, coatings of rare earth phosphate prepared from a paint formulation in aqueous medium and coated to substrates of ceramics and metal is also shown to be non reactive of molten metals.

In metal casting operations, the mould walls are generally coated with release agents to prevent corrosion of the mould wall with molten metal and also to prevent the adherence of cast part on to the mould walls. The release agents thus facilitate easy release of cast part from the moulds. The prior art of mould release coatings is based on materials like hexagonal boron nitride, graphite etc which provide an interfacial layer between the mould and cast part. The present invention introduces rare earth phosphate based compositions as suitable materials for non-reactivity and non-wettability with molten metals like zinc and aluminium. Rare earth phosphate based powders dispersed in aqueous medium can be applied as coatings on suitable moulds for the casting purpose. Alternatively lanthanum phosphate based rare earth phosphate containers in the form of crucibles can be obtained from the aqueous dispersions of adequate solid loading and can be used directly for casting simple shapes of metal.

The process begins with the preparation of rare earth phosphates like lanthanum phosphate powders by a modified sol gel process. Solutions of lanthanum salts in water at molar concentrations in the range 0.01 to 0.1 are treated with orthophosphoric acid at 25-35° C. The precipitate thus obtained is subjected to a flocculation procedure at pH 7 and further washed repeatedly with water to free of the chloride/nitrate ions. The washed precipitate is then peptized to a sol at pH 2. The sol is then calcined to obtain powders of typically nanorod morphology with lengths up to 1 micron and width of 10-15 nm.

According to one aspect of the invention, the powder is made into a paint formulation with appropriate solid loading by employing suitable binders and plasticizers and coated to containers currently employed in foundry for molten metal casting. The coated crucibles are dried under controlled humidity conditions to ensure crack free film formation and further heat treated at temperatures greater than 800° C. The coated foundry crucibles thus obtained can be employed for molten metal casting operations wherein the coating layer is non-wetting and non-reactive to molten metals.

According to another aspect of invention, monoliths of lanthanum phosphate in the form of crucibles for example, can be cast from aqueous slurry of the powder with solid loading in the range of 60 to 75 wt %. The powder is dispersed in water under controlled pH conditions and milled appropriately with alumina milling media for 5-15 hrs. Slurry is further deaired and poured onto plaster of paris moulds in a slip casting procedure. After sufficient buildup of thickness the excess slurry is drained and the cast shape is subjected to ambient air drying until they are released from the moulds. The dried monoliths after an oven drying at 80° C. is then subjected to sintering at temperatures varying in the range of 1300-1600° C. Crack free sintered crucibles of lanthanum phosphate are thus obtained and can be directly employed for molten metal casting operations

The invention more specifically relates to the synthesis and dispersion of lanthanum phosphate powders in an aqueous medium followed by its shaping to monoliths by slip casting and sintering to perform as non-reactive containers for molten metal casting. In another embodiment the aqueous/organic dispersions of rare earth phosphates with suitable solid loading and binders can perform as paint/spray formulations for application as coatings on other glass, ceramic and metallic substrates. Another embodiment of the invention relates to the non-wettability of such monoliths and coatings with molten metals at their respective melting temperatures.

### EXAMPLES

Following examples are given by way of illustration and therefore should not be construed to limit the scope of the invention.

### Example I

### Preparation of Lanthanum Phosphate Nanorods Powder

In a typical synthesis for 20 g Lanthanum Phosphate, 37.0198 g Lanthanum nitrate was initially dissolved in 1710 ml de-mineralized water to form lanthanum nitrate hexahydrate. Lanthanum phosphate was precipitated by adding the phosphate source 88% ortho phosphoric Acid (5.44 ml) drop by drop and the precipitate formed is further flocculated by addition of 25% ammonia solution and pH was raised to 7. The precipitate was then washed with luke warm water. The washed precipitate was then filtered and redispersed in de-mineralized water and further peptized to form lanthanum phosphate sol (pH 2) using 20% nitric acid with continuous, vigorous stirring to obtain the sol. The stability of the sol is checked using zeta potential measurement.

### Example 2

In another example, mixture of rare earth nitrates comprising the elements of La, Pr, Sm and Ce was dissolved in demineralized water and treated with stoichiometric amounts to precipitate the rare earth phosphate mixture. The precipitate was treated as mentioned in example 1 and made into a sol containing the mixture of rare earth phosphates.

### Example

### Example 3

### Coating of Lanthanum Phosphate Nanoroads Powder

The sols thus obtained in example land 2 was mixed with poly vinyl alcohol, sprayed or coated over surfaces and annealed to get coatings.

### Example 4

### Preparation of Containers/Monoliths

Lanthanum Phosphate precipitated from Lanthanum salt by adding ortho phosphoric acid is further flocculated by addition of 25% ammonia solution till the pH was maintained between 6.8-7.8. The precipitate thus obtained was washed, dried and calcined at 1000-1200° C. to obtain Lanthanum phosphate powders. The powders were then dispersed in water at pH 2 and ball milled for 6-12 h using alumina as milling medium. 1-2 drops of octanol was added to the suspension to prevent foaming. The slurry after deairing was slip cast to shapes of crucibles and containers using Plaster of Paris moulds. After the build-up of sufficient thickness the slip cast part was de-moulded and dried at 80° C. under controlled conditions of humidity and temperature (50° C. and 65-75% RH) and further under normal oven conditions for 15 h at 80° C. The dried monolith is then sintered in the temperature range 1300-1500° C. and the crack free monoliths thus obtained are used for aluminum metal casting.

### Advantages of the Invention

Rare earth phosphate based non-reactive surfaces obtained by the process described in this invention provides non-reactive, non-wetting characteristics towards molten metals. This property enables the development of mould release coatings in metallurgical industry for casting operations
The formulations thus developed substitute the highly expensive material of boron nitride used commonly for the said purposes
The dispersibility of powders in aqueous/organic media enables the formation of paintable/sprayable formulations conducive for industrial environments compared to physical/chemical vapour deposition processes that require sophisticated instrumentation
The developed powders are also amenable to environmentally benign colloidal forming techniques that promote monolith fabrication
The non-wettability and non-reactive nature of the surfaces enable repeated use of containers and helps in minimum material losses when used for precious metal castings of gold and silver.

1. A metallophobic ceramic monolith made of nano rare-earth phosphates having density in the range of 96-99% (4.8-4.9 g/cc) of theoretical density for rendering a non-wetting and non-reactive surface to handle molten metals.

2. The metallophobic ceramic monolith, as claimed in claim 1, for providing a non-reacting and non-adhering surface in foundry and metallurgical applications for holding the molten metal at the melting temperature (up to 1200° C.) for 3-6 hours.

3. The metallophobic ceramic monolith as claimed in claim 1, wherein the molten metal comprises metallic elements alone or metallic elements in combination with alloys, metal composites, transition metals and semi metals.

4. The metallophobic ceramic monolith as claimed in claim 4, wherein the metallic element is Aluminium, Silver or Zinc.

5. The metallophobic ceramic monolith as claimed in claim 1, wherein the monolithic surface is formed by consolidation of nanopowders using suitable binders selected from the group of polyvinyl alcohol, methyl cellulose, ethyl cellulose, poly vinyl pyrrolidone.

6. A process for making metallophobic ceramic monolith, made of nano rare-earth phosphates, having density in the range of 96-99% (4.8-4.9 g/cc) of theoretical density for rendering a non-wetting and non-reactive surface to handle molten metals, comprising the steps of
(a) Spray granulating rare earth phosphate nanorods into granules of desired sizes in the range of 1 to 100μπι
(b) Compaction processing of the above granules under uniaxial and isostatic load to obtain samples of green density of 45-55% Theoretical Density.
(c) Coarsening the nanorods by high temperature calcination process and re-dispersion in aqueous medium with adequate binder to obtain a slurry having more than 70% solid
loading and pouring them to porous moulds of varying shapes to obtain shaped monoliths having green density equal to 50% of theoretical density
(d) Drying of samples obtained from 1(b) and 1(c) under controlled conditions (for e.g.: 45° C. and 75% RH) to obtain crack free specimens with minimum liquid content
(e) High temperature treatment of above samples to obtain crack free monoliths of greater than 95% theoretical density.

7. A ceramic coating over crucibles or containers, obtained by coarsening rare earth phosphate nanorods by high temperature calcination process and re-dispersion in aqueous medium with adequate binder to obtain slurry having more than 70% solid loading and allowing it to heat treatment, so as to obtain non-wetting and non-reactive surfaces on heat treatment.

8. The metallophobic crucible or container as claimed in claim 7 for providing a non-reacting and non-adhering surface in foundry and metallurgical applications for holding the molten metal for 3-6 hours at the melting temperature up to 1200° C.

9. The metallophobic crucible or container as claimed in claim 7, wherein the molten metal comprises metallic elements alone or metallic elements in combination with alloys, metal composites, transition metals and semi metals.

10. The metallophobic crucible or container as claimed in claim 7, wherein the metallic element is Aluminium, Silver or Zinc.

11. The A process for obtaining non-wetting and nonreactive surfaces as claimed in claim 7 by coarsening rare earth phosphate nanorods by high temperature calcination process and re-dispersion in aqueous medium with adequate binder to obtain slurry having more than 70% solid loading and allowing it to heat treatment for obtaining an adherent film.
